(19) United States
(12) Patent Application Publication
(10) Pub. No.: US 2025/0029454 A1
(43) Pub. Date: Jan. 23, 2025

(54) Sports Gaming System Using Team Metrics

(71) Applicants: Tully Bradford Minoski, Mission, KS (US); Marc Clifford Fiedler, Arlington, VA (US); Matthew Thomas Lynch, Fairfax, VA (US)

(72) Inventors: Tully Bradford Minoski, Mission, KS (US); Marc Clifford Fiedler, Arlington, VA (US); Matthew Thomas Lynch, Fairfax, VA (US)

(21) Appl. No.: 18/354,701

(22) Filed: Jul. 19, 2023

(51) Int. Cl. G07F 17/32

(52) U.S. Cl. CPC G07F 17/3288

(57) ABSTRACT

A computer-implemented sports gaming system wherein game participants draft real-life sports teams and game participant's scores or rankings are based on two or more team metrics produced by those teams in real-life games.

### CROSS-REFERENCE TO RELATED APPLICATIONS

Not applicable.

### BACKGROUND OF THE INVENTION

Fantasy sports games involve creating a league of fantasy teams populated by real-life athletes participating in real-life sports games. Participants in fantasy sports games draft individual players (from different real-life teams) to create the participant's fantasy team. After real-life games, statistics generated by the drafted players are converted to fantasy points in accordance with league rules, and those points are assigned to the corresponding fantasy team(s). Fantasy points are added at the end of the league's season, and the fantasy team with the most fantasy points wins the fantasy contest. An example of a such a fantasy sports game is described in U.S. Pat. No. 10,427,053.

Many participants in fantasy sports games conduct research to inform which real-life players they should draft to their fantasy teams. Many participants enjoy this research and invest considerable time and effort in this effort. But such research can be burdensome for some sports gaming enthusiasts, and consequently they may decide not to participate in fantasy sports or elect to participate in a simpler gaming system—for example, one where participants merely predict the winners of a given set of sports games.

Between these two gaming systems lies an unrealized opportunity to create a new sports gaming system: one where, instead of participants drafting players corresponding to real-life athletes and participant rankings being based on the statistics generated by those individuals, the participants select real-life sports teams, and participant scores or rankings are based on multiple team statistics generated by those teams in real-life games.

The appeal of this gaming system is that it does not require extensive research at the player level but generates participant enthusiasm about real-life teams, similarly to the way traditional fantasy games generate enthusiasm about real-life players.

### BRIEF SUMMARY OF THE INVENTION

The invention described and claimed herein comprises a computer-implemented sports gaming method and system wherein game participants select real-life teams and scoring occurs at the team level. Real-life team results (wins/losses) are modified using other team metrics in accordance with league rules. A computer (or network of computers) is configured to (i) to store a set of instructions embodying league rules, (ii) receive team selections and team metrics, and (iii) calculate game participant scores or rankings based upon team selections, team metrics, and the set of instructions (including instructions for scoring or ranking based on at least two team metrics).

In one embodiment, a computer-implemented method for operating a sports gaming system comprises (a) storing in memory a set of instructions for operating the sports gaming system, including instructions for using at least two team metrics from real-life games and pre-set values assigned to those metrics as the basis for game participant scores, (b) sending a list of teams available for selection to game participants, wherein the teams are real-life teams from a professional or collegiate team sports league, (c) receiving a list of teams selected by each game participant, (d) receiving team metrics from real-life games for the selected teams, (e) calculating game participant scores by applying the instructions for calculating scores to the team metrics for the selected teams, and (f) determining a winner at the end of a predetermined time by adding the cumulative scores from step (e). Steps (a)-(f) may be performed in a single server, or they may be performed by multiple servers linked in a network.

The real-life professional sports league may be any league for a professional team sport, such as the National Football League, the National Basketball Association, the National Hockey League, Major League Baseball, Major League Soccer, the English Premier League, or the European League of Football. In a preferred embodiment, the real-life professional sports team is the NFL. The real-life collegiate sports league may be any league for a collegiate team sport, such as NCAA college football (including individual NCAA football conferences) or NCAA men's college basketball (including individual NCAA basketball conferences).

Rules for team selection may be stored in memory as part of the set of instructions. The instructions may permit game participants to select any team in the league or, in a preferred embodiment, may limit the selection of each team to one game participant. The instructions may specify a selection sequence for game participants to select teams. For example, when each participant selects one team (as when the number of teams in the league equals the number of game participants), the set of instructions may specify a random team selection sequence. When each participant selects two or more teams (as when the number of teams in the league exceeds the number of game participants by at least a factor of two), the instructions may employ a random draft for the first round and a snake draft for subsequent rounds, i.e., a draft where the team selection sequence is reversed for each subsequent round of the draft.

The team metrics used to calculate game participant scores may be any team metrics routinely measured and available on sports data servers. For example, in a preferred embodiment where the sports league is the National Football League, the team metrics may be selected from, inter alia, wins, points scored, point differential, or betting lines. As another example, when the sport league is the National Hockey League, the team metrics may be selected from, inter alia, wins, points, goal differential, or betting lines.

The pre-set values assigned to at least two metrics may be any numerical values. For example, a “win” may be worth 10 points and “beating the spread” may be worth 5 points. The values chosen may be selected to give greater or lesser weight to a particular metric. For example, if “winning” is considered the most important metric, a high value may be assigned to a game win. Similarly, if offensive production is considered more important than defensive results, a higher value may be given to points scored (or goals/runs scored) than to point differential (or goal/run differential).

In another embodiment, a computer implemented sports gaming system comprises (a) computer memory configured to store a set of instructions, and (b) one or more computer processors configured to execute the set of instructions and perform a series of operations. That series of operations may include (i) providing a list of available teams to game participants for selection, wherein the teams are real-life teams from a professional or collegiate team sports league, (ii) receiving team selections from each participant, (iii) selecting at least two team metrics to be used in determining game participant scores, (iv) assigning a pre-set value to each team metric to be used in determining game participant scores, (v) receiving team metrics from real-life games from a sports data source, (vi) applying the pre-set values to the team metrics received from a sports data source, and (vii) determining a winner at the end of a predetermined time by adding the cumulative values from operation (vi).

In a further embodiment, a computer-implemented method for operating a sports gaming system comprises (a) storing a set of instructions for operating the sports gaming system, including instructions for ranking game participants based on at least two team metrics from real-life games, (b) sending a list of teams available for selection to game participants, wherein the teams are real-life teams from a professional or collegiate team sports league, (c) receiving a list of teams selected by each game participant, (d) receiving team metrics from real-life games involving the selected teams, (e) ranking game participants by applying the instructions for ranking participants to the team metrics for the selected teams, and (f) determining a winner by ranking participants at the end of a predetermined time by applying the instructions for ranking participants to the cumulative team metrics for the selected teams. In a preferred embodiment, one of the team metrics used for ranking game participants is game wins, and a second team metric serves as a tiebreaker when two or more game participants have an equal number of wins at the end of the predetermined time.

### BRIEF DESCRIPTION OF THE DRAWINGS

FIG. 1 is an illustration of a sports gaming network of an embodiment of the sports gaming system described herein; and

FIG. 2 is a flow diagram of an illustrative process for practicing the sports gaming method described herein.

### DETAILED DESCRIPTION OF THE INVENTION

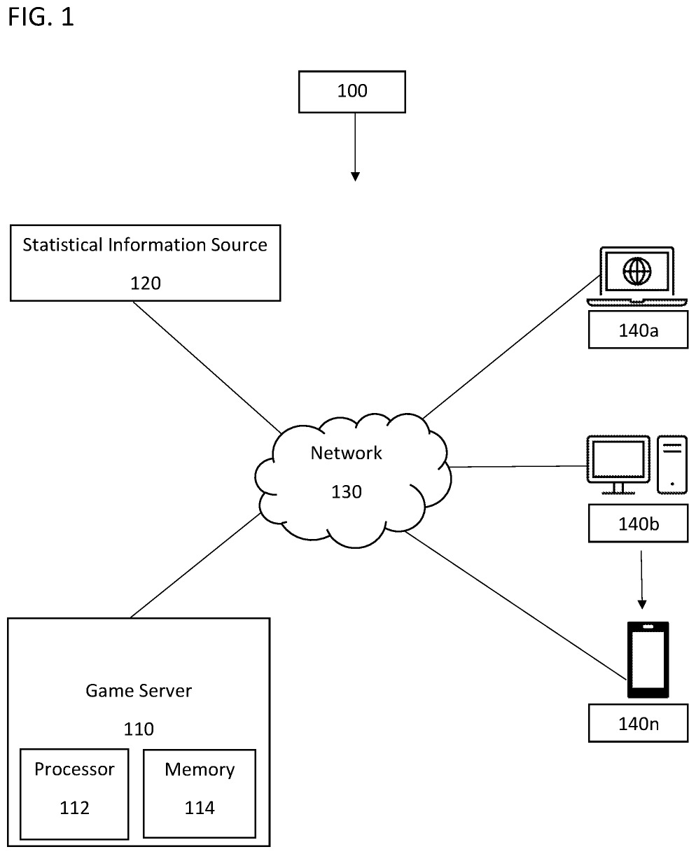

Referring to FIG. 1, a sports gaming system 100 is depicted. System 100 may include a server 110 containing at least one processor 112 and at least one memory 114. System 100 may also include sports data source 120, a communications network 130, and one or more participant terminals 140a-140n (collectively 140). The different elements and components of the system may communicate with one another using wireless communications or hardwired communications such as fiber optics or cable.

The communications network 130 may include any number of networks capable of providing communications between the server 110, the sports data source 120, and the terminals 140. For example, the communications network 130 may be one or more wireless networks, data or packet networks, or publicly switched telephone networks (PSTN).

The participant terminals 140 may include any suitable device operable to act as a client on a network. Illustrative participant terminals 140 include personal computers, desktop computers, laptop computers, servers, or any suitable telecommunications device, including VOIP telephones, smart telephones, or wireless devices such as cellular telephones and personal digital assistants (PDA). Each terminal 140 may be configured to transmit and/or receive information to or from the server 110, the sports data information source 120, and/or participant terminals 140.

In accordance with the invention, the sports data source 120 includes statistical information related to real-life teams participating in real-life games, and it may be comprised of one or more sports data sources. The sports data source 120 may be any suitable source of sports team statistical data. The sports data source 120 may be a statistical repository maintained by a sports league, such as the National Football League (NFL), the National Collegiate Athletic Association (NCAA), the National Basketball Association (NBA), the National Hockey League (NHL), Major League Soccer (MLS), Major League Baseball (MLB), etc. Alternatively, the sports data source may be a third-party source, such as pro-football-reference.com (NFL statistics), sports-reference.com (NCAA statistics), basketball-reference.com (NBA), hockey-reference.com (NHL statistics), fbref.com (MLS statistics), and baseball-reference.com (MLB statistics).

The server 110 may be any server, computer or device configured to process commands from the participant terminals 140, and it may be one or more servers. In one embodiment, as illustrated in FIG. 1, the server includes at least one processor 112 and at least one memory 114. However, the claimed invention may be implemented in hardware, software, or a suitable combination of hardware and software, including one or more software programs operating on a general-purpose server platform. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable architectures. In one exemplary embodiment, a software system can include one or more lines of code in a general-purpose software application, such as an operating system, or one or more lines of code in a specific purpose software application. Alternatively, the functions of the server may be performed by a human user as a commissioner for a sports gaming contest. The method may be implemented by a server, wireless device, VoIP telephone, other advanced intelligence network device, or any combination thereof, generally referred to herein as the “device.”

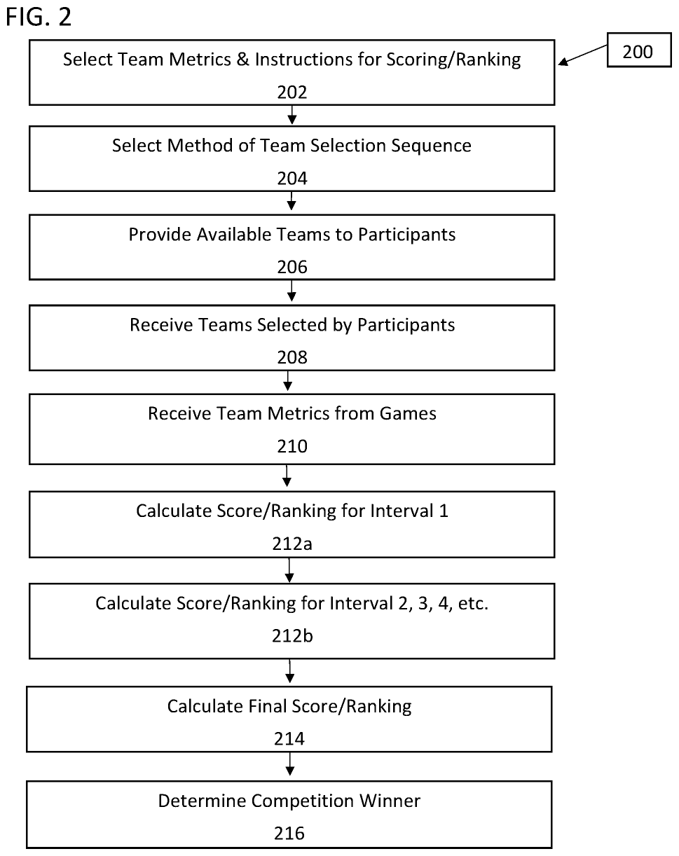

Referring now to FIG. 2, a flowchart 200 of a method for playing a sports gaming contest in accordance with the claimed invention. The method may be implemented by a server, wireless device, VoIP telephone, or other advanced intelligence network device, or any combination thereof, generally referred to herein as the “device.” Alternatively, the method may be performed by a human user acting as a commissioner of a sports gaming contest. Although the illustrated embodiments employ the game of American football, it will be appreciated that this sport is used for illustrative purposes only and that any suitable professional or collegiate team sport may be used may be used in the claimed invention.

Method 200 may be practiced in the sequence presented in FIG. 2, or it may be practiced in a different sequence. In FIG. 2, method 200 begins with selecting the rules for scoring the contest using team metrics, step 202, and for selecting the sequence in which game participants choose their teams, step 204. In one embodiment, these rules are pre-set and participants accept rules by agreeing to play the contest. In an alternative embodiment, participants may select the rules for the contest among a variety of options stored in memory.

In accordance with the invention, the rules for scoring are based on at least two team statistics. Team statistics are cumulative team statistics over the course of the contest and may include any team statistics that are available via sports data sources. In the case of American football, those statistics could include, for example, game wins (game wins and losses are considered one team statistic), team points scored, point differential (the difference between points scored and points allowed by a team), team yards gained, team rushing yards, team passing yards, team touchdowns, team results versus betting lines (for example, whether the team met or exceeded the point spread predicted for a game). The scoring may be based on the actual results from the games (for example, number or wins) or be based a value assigned those results (for example, 10 points for every win).

The rules for setting the team selection sequence may depend upon the number of game participants and the number of teams in the league that is subject to the contest, and they may depend upon whether more than one game participant is permitted to select the same team. In a preferred embodiment, each team can by selected by only one game participant, which places a premium on the order in which game participants select teams. In a more preferred embodiment, the contest involves half, or fewer, as many participants as teams in the league, which allows each participant to select at least two teams. In this more preferred embodiment, a snake draft (in which the draft order reverses between the first two rounds of team selection) can be used. Draft order in the first round can be randomized by the device. Teams may be selected for the duration of the contest, or a redraft may occur on a periodic basis such as weekly. Periodic drafts are one way to make contests competitive in situations where the number of game participants requires that each participant can select only a single team.

Once the draft order is established, step 206 provides a list of available teams sequentially to the game participants. In step 208, the device receives the selections made by the game participants. As games are played, the device receives team statistics in step 210 and, in step 212a, calculates scores or rankings at a predetermined time. In step 212b, these scores or rankings can be recalculated periodically at predetermined intervals, preferably weekly in the case of a contest based on the NFL. At the conclusion of a designated period, preferably at the end of the league season, the device calculates a final score or ranking in step 214 and determines a winner in step 216.

### EXAMPLE 1

In a sports gaming contest, the rules of the contest are set as follows: (i) the league for the contest is the NFL, consisting of 32 teams; (ii) sixteen game participants engage in the contest; (iii) each NFL team is selected by a single game participant, meaning each game participant selects two teams; (iv) the team selection sequence employs a snake draft, with the sequence of the first draft round determined randomly; (v) participants retain the same teams throughout the contest; (vi) two metrics are used for scoring—total team wins for the two teams selected by the participant, and total team point differential for those teams; (vii) total team wins determines the contest winner unless there is a tie in the number of wins, in which case total team point differential is used as a tie-breaker and determines the contest winner; (viii) interim scores are calculated and distributed weekly to participants; and (ix) the contest ends after completion of the NFL's regular season, at which time the winner is determined.

These rules are loaded into computer memory along with the teams selected by the game participants. A computer processor calculates gaming participant scores on a weekly basis using the sports team selections made by the gaming participants, team metrics received from a sports data source, and the set of instructions stored in memory. At the end of the NFL's regular season, the total wins of teams selected by two game participants are equal. For the two teams selected by one of the tied participants, the total point differential for one team is +76 and the total point differential for the other team is −02, for a collective total of +74. For the two teams selected by the second tied participant, the total point differential for one team is +53 and the total point differential for the other team is +37, for a collective total of +90. Accordingly, the latter is declared the winner.

### EXAMPLE 2

In a sports gaming contest, the rules of the contest are set as follows: (i) the league for the contest is the NFL, which consists of 32 teams; (ii) sixteen game participants engage in the contest; (iii) each NFL team is selected by a single game participant, meaning each game participant selects two teams; (iv) the team selection sequence employs a snake draft, with the sequence of the first draft round determined randomly; (v) three metrics are used for scoring—total team wins for the two teams selected by each participant, total points scored for those teams, and success in beating the betting point spread; (vi) values ascribed to these team metrics are as follows: +25, 0, or −25 points for wins, ties, or losses, points equal to the total points scored, and +10, 0, or −10 for beating, matching, or losing against the betting point spread in each game; (vii) total points determines the contest winner; (viii) interim scores are calculated and distributed to the participants weekly; and (ix) the contest ends after completion of the NFL regular season, at which time the winner is determined.

These rules are loaded into computer memory along with the teams selected by the game participants. A computer processor calculates gaming participant scores on a weekly basis using the sports team selections made by the gaming participants, team metrics received from a sports data source, and the set of instructions stored in memory. At the end of the NFL's regular season, the processor calculates a final score based on total points for each participant and determines a winner based on who has the highest score.

A workflow analysis shown in the APPENDIX illustrates how the components of the sports gaming system interact in Example 2 and how computer software may be scripted to automate certain functions.

This disclosure describes the best mode of practicing the claimed invention, including various preferred embodiments. The disclosure, however, is not limited to the described embodiments and is intended to cover various modifications and arrangements within the spirit and scope of the broadest interpretation of the claims, including all equivalent modifications and arrangements.

### APPENDIX

### Gather Initial Data

Import from user the league of choice
Import from user the list of participants
Import from user the number of teams per participant
Import from user the method of draft
Import from user the competition metrics
Import from a server the teams in the league (for example, 32 Teams from NFL)
Imported data is stored in computer memory

### Draft Teams

Game participants are manually or electronically placed into a drafting order.
Algorithm is applied to draft order using snake draft algorithm:
   For Participant 1 until [Total # of Participants]
   Participant [x] picks a Team from the League: Participant [x].Team1
   Computer processor processes selection
   Computer memory stores selection
   Computer processor marks the team as unavailable for selection
   Team is no longer available to other participants
Repeat algorithm with Participant [x+1] until reaching [Total # of Participants]
Repeat algorithm in reverse order:
   For Participants [Total # of Participants] until Participant 1
   Participant [Total # of Participants] picks a Team from the League: Participant [x].Team2
   Computer processor processes selection
   Computer memory stores selection
   Computer processor marks the team as unavailable for selection
   Team is no longer available to other participants
Repeat algorithm with next Participant [Total # of Participants]—1 until reaching Participant 1
Repeat Until Number of Teams remaining is less than [Total # of Participants]
At the end of the draft, each participant has a unique set of teams: Participant [x] (Team1, Team2),
Participant [y] (Team3, Team4), Participant [z] (Team5, Team6), etc.

### Weekly Scoring.

At the end of the week, each Team has four metrics evaluated: Team [x]. (Bye, Win/Loss, Total Points, Spread Bonus)
At the end of the week, each Participant has a Participant [x].WeekScore, and a cumulative Participant [x].SeasonScore
   Import weekly sports data from server

### Apply Algorithm:

Team [x].Bye=True/False. If true, participant does not compete in weekly competition
Team [x].WinLoss=25 for Win, 0 for Tie, −25 for Loss
Team [x].Points=Points Scored
Team [x].Spread=+10 for Over, 0 for Matched, −10 Under
   Repeat until all team results imported
   Computer processor calculates score for all participants involved
For Participant 1 until [Total # of Participants]
If Participant [x].Team1.Bye=True, skip to next participant
Participant [x].WeekScore=Sum of:
   Participant [x].Team1.Winloss
   Participant [x].Team1.Points
   Participant [x].Team1.Spread
   Participant [x].Team2.Winloss
   Participant [x].Team2.Points
   Participant [x].Team2.Spread
   Participant [x].Team [x] . . . etc
Participant [x].SeasonScore=Participant [x].SeasonScore+Participant [x].WeekScore
Repeat with next Participant [x]+1 Until reaching [Total # of Participants]
   Computer memory stores results
   Computer processor sorts each Participant [x].WeekScore highest to lowest
   Highest Participant [x].WeekScore wins for the week
   Lowest Participant [x].WeekScore loses for the week

### Determine Season Winner

Sort each Participant [x].SeasonScore highest to lowest
Highest Player [x].SeasonScore wins the season

1. A computer-implemented method for operating a sports gaming system comprising:
(a) storing in memory a set of instructions for operating the sports gaming system, including instructions for using at least two team metrics from real-life games and pre-set values assigned to those metrics as the basis for game participant scores,
(b) sending a list of teams available for selection to game participants, wherein the teams are real-life teams from a professional or collegiate team sports league,
(c) receiving a list of teams selected by each game participant,
(d) receiving team metrics from real-life games for the selected teams,
(e) calculating game participant scores by applying the instructions for calculating scores stored in step (a) to the team metrics received in step (d) for the teams selected in step (c),
(f) determining a winner at the end of a predetermined time by adding the cumulative scores from step (e).

2. The method of claim 1 wherein steps (a)-(f) take place in a single server.

3. The method of claim 1 wherein the real-life professional sports league is the National Football League.

4. The method of claim 1 wherein the team metrics are selected from the group including wins, points scored, point differential, and betting lines.

5. The method of claim 1 wherein the real-life collegiate sports league is selected from NCAA college football and its individual conferences, and NCAA college basketball and its individual conferences.

6. The method of claim 1 wherein step (a) includes storing a set of instructions that limits the selection of each team to one game participant and specifies a team selection sequence for the game participants.

7. The method of claim 6 wherein step (a) includes storing a set of instructions that permits each game participant to select more than one team and employs a snake draft to decide the team selection sequence.

8. A computer implemented sports gaming system comprising:
(a) computer memory configured to store a set of instructions, and
(b) one or more computer processors configured to execute the set of instructions and perform a series of operations comprising:
(i) providing a list of available teams to game participants for selection, wherein the teams are real-life teams from a professional or collegiate team sports league,
(ii) receiving team selections from each participant,
(iii) selecting at least two team metrics to be used in determining game participant scores,
(iv) assigning a pre-set value to each of the team metrics to be used in determining game participant scores,
(v) receiving team metrics from real-life games from a sports data source,
(vi) applying the pre-set values to the team metrics received from real-life games, and
(vii) determining a winner at the end of a predetermined time by adding the cumulative values from operation (vi).

9. A computer-implemented method for operating a sports gaming system comprising:
(a) storing a set of instructions for operating the sports gaming system, including instructions for ranking game participants using at least two team metrics from real-life games,
(b) sending a list of teams available for selection to game participants, wherein the teams are real-life teams from a professional or collegiate team sports league,
(c) receiving a list of teams selected by each game participant,
(d) receiving team metrics from real-life games involving the teams selected,
(e) ranking the game participants by applying the instructions for ranking participants to the team metrics for the selected teams, and
(f) determining a winner by ranking participants at the end of a predetermined time by applying the instructions for ranking participants to the cumulative team metrics for the selected teams.

10. The method of claim 9 wherein one of the team metrics used for calculating game participant rankings is game wins, and a second team metric serves as a tiebreaker when two or more game participants have an equal number of wins at the end of the predetermined time.
